(19) United States
(12) Patent Application Publication
(10) Pub. No.: US 2007/0182880 A1
(43) Pub. Date: Aug. 9, 2007

(54) Backlight unit

(75) Inventor: Tatsuro Yamada, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD.

(21) Appl. No.: 11/701,639

(22) Filed: Feb. 2, 2007

(30) Foreign Application Priority Data
Feb. 3, 2006 (JP) JP2006-027372

(51) Int. Cl. G02F 1/1335

(52) U.S. Cl. 349/61

(57) ABSTRACT

A backlight unit provided between first and second parallel liquid crystal panels to illuminate both of them has a light source and a light guide plate that receives light from the light source and that emits light for illuminating the two liquid crystal panels. A shielding-reflecting sheet having an opening is disposed between the second liquid crystal panel and the light guide plate. The light from the light guide plate passes through the opening toward the second liquid crystal panel. The light reflectances of surfaces of the shielding-reflecting sheet and the second liquid crystal panel that face the light guide plate are set substantially equal. An annular frame surrounds the peripheral edge of the light guide plate. The frame has a first end surface on the first liquid crystal panel side thereof and a second end surface on the second liquid crystal panel side thereof. The shielding-reflecting sheet is fixed to the second end surface of the frame to form, in cooperation with the frame, a casing that houses the light source and the light guide plate.

This application claims priority under 35 U.S.C. §119 to Japanese Patent Application No. JP2006-027372 filed Feb. 3, 2006, the entire content of which is hereby incorporated by reference.

### BACKGROUND OF THE INVENTION

1. Field of the Invention

The present invention relates to backlight units for use in display devices such as liquid crystal display devices. More particularly, the present invention relates to a backlight unit for a liquid crystal display device used in a portable cellular phone and so forth capable of double-sided display.

2. Description of the Related Arts

Among recent cellular phones is one that has a liquid crystal panel on one side of a thin casing of the cellular phone to form a first display part with a large screen size and that has another liquid crystal panel on the other side of the casing to form a second display part with a small screen size. There has been developed a technique of illuminating such two liquid crystal panels with a single backlight unit (for example, see Japanese Patent Application Publication No. 2005-209618).

Such backlight units according to the conventional art will be explained below with reference to FIGS. 4 and 5. A backlight unit 10 shown in FIG. 4 has a casing 3, an LED light source 4 using LEDs (light-emitting diodes), a light guide plate 5, a semitransmitting-reflecting sheet 6, a diffusing sheet 7, and prism sheets 8 and 9, which are housed in the casing 3. A first liquid crystal panel 1 with a large screen size and a second liquid crystal panel 2 with a small screen size are placed to face each other across the backlight unit 10.

The LED light source 4 is positioned adjacent to one end edge surface of the light guide plate 5. The light guide plate 5 receives light emitted from the LED light source 4 and emits light from upper and lower (as seen in the figures) light emitting surfaces of the light guide plate 5. Light emitted from one light emitting surface of the light guide plate 5 is applied to the first liquid crystal panel 1 through the diffusing sheet 7 and the prism sheets 8 and 9. Light emitted from the other light emitting surface of the light guide plate 5 is applied to the second liquid crystal panel 2 through the semitransmitting-reflecting sheet 6 and an opening 13 formed in a bottom wall 11 of the casing 3.

FIG. 5 shows an example of a backlight unit 20 used when the second liquid crystal panel 2 requires a particularly high brightness. In the backlight unit 20, the casing 3a is provided with an annular wall 14 that projects outward from the bottom wall 11 surrounding the opening 13 formed in the bottom wall 11. A stack of prism sheets 15 and 16 is disposed inside the annular wall 14. The second liquid crystal panel 2 is placed at a position facing the prism sheets 15 and 16. The rest of the backlight unit 20 is the same as that of the above-described backlight unit 10, which is shown in FIG. 4.

The above-described conventional backlight units suffer, however, from the problem of brightness unevenness. That is, light emitted from the light guide plate 5 toward the second liquid crystal panel 2 is reflected by the inner surface of the bottom wall 11 except the opening 13. Therefore, when the first liquid crystal panel 1 is viewed, a region thereof that corresponds to the opening 13 of the casing bottom wall 11 appears dark, and the rest of the first liquid crystal panel 1 appears bright because of light reflected from the casing bottom wall 11. Attempts have been made to reduce the brightness unevenness, for example, by adjusting the color of the casing bottom wall 11 so that the reflectance of the bottom wall 11 is reduced. Reducing the reflectance of the casing bottom wall 11, however, causes the brightness of the first liquid crystal panel 1 to degrade undesirably.

Meanwhile, it is demanded that portable devices such as cellular phones reduce in size and thickness. In the conventional backlight units, however, it is difficult to reduce the thickness s of the casing bottom wall 11 owing to the difficulty in molding process. The thickness s of the bottom wall 11 cannot be reduced to less than about 0.5 mm. For this reason, it is impossible to reduce the thickness a of the backlight unit 10 shown in FIG. 4 and the thickness b of the backlight unit 20 shown in FIG. 5.

### SUMMARY OF THE INVENTION

Accordingly, an object of the present invention is to provide a backlight unit capable of solving the above-described problems with the conventional art.

The present invention provides a backlight unit that is provided between a first liquid crystal panel and a second liquid crystal panel, which are disposed parallel to each other, to illuminate both the first and second liquid crystal panels. The backlight unit includes a light source and a light guide plate that receives light emitted from the light source and that emits light for illuminating the first and second liquid crystal panels. A shielding-reflecting sheet is disposed between the second liquid crystal panel and the light guide plate in parallel to them to shield and reflect light emitted from the light guide plate. The shielding-reflecting sheet has an opening through which light emitted from the light guide plate passes toward the second liquid crystal panel. Respective surfaces of the shielding-reflecting sheet and the second liquid crystal panel that face the light guide plate have respective reflectances that are set so that light emitted from the light guide plate toward the second liquid crystal panel is reflected back to the light guide plate uniformly across the light guide plate by the surfaces of the shielding-reflecting sheet and the second liquid crystal panel.

In the backlight unit according to the present invention, the respective surfaces of the shielding-reflecting sheet and the second liquid crystal panel that face the light guide plate have respective reflectances that are set so that light emitted from the light guide plate toward the second liquid crystal panel is reflected back to the light guide plate uniformly by the surfaces of the shielding-reflecting sheet and the second liquid crystal panel. Therefore, the above-described problem of brightness unevenness on the first liquid crystal panel can be solved.

Specifically, the reflectance of the surface of the shielding-reflecting sheet that faces the light guide plate and the reflectance of the surface of the second liquid crystal panel that faces the light guide plate may be set equal to each other. The surface of the shielding-reflecting sheet that faces the light guide plate may be colored to adjust the reflectance thereof.

The backlight unit may further include a frame installed so as to surround the peripheral edge of the light guide plate and having a first end surface on a side thereof closer to the first liquid crystal panel and a second end surface on a side thereof closer to the second liquid crystal panel. The shielding-reflecting sheet is fixed to the second end surface of the frame to form, in cooperation with the frame, a casing-like configuration that houses the light source and the light guide plate.

In this backlight unit, the bottom wall of the casing in the above-described conventional backlight units is eliminated. Therefore, the backlight unit can be reduced in thickness.

The backlight unit may further include a semitransmitting-reflecting sheet disposed between the shielding-reflecting sheet and the light guide plate.

In this case, the semitransmitting-reflecting sheet may be fixed to the second end surface of the frame to stretch, and a peripheral edge portion of the shielding-reflecting sheet may be fixed to the second end surface of the frame through the semitransmitting-reflecting sheet.

In this case, the light guide plate is preferably secured to the inner peripheral surface of the frame.

Specifically, the arrangement may be as follows. The light guide plate is rectangular and has a rectilinear end edge surface for receiving light from the light source and an end edge surface opposite to the rectilinear end edge surface. The light guide plate further has first and second side edge surfaces extending between the two end edge surfaces. The frame has first and second inner surfaces positioned to face the first and second side edge surfaces, respectively, of the light guide plate to fixedly support the first and second side edge surfaces.

More specifically, the arrangement may be as follows. The first and second inner surfaces of the frame are disposed adjacent to the first and second side edge surfaces of the light guide plate. The light guide plate has a first surface flush with the second end surface of the frame and a second surface located closer to the first end surface of the frame than the first surface. The frame has on the second end surface at least one first recess that is recessed outwardly of the frame from each of the first and second inner surfaces. The second end surface of the frame is configured to have at least one first recess extending outwardly of the frame from the first inner surface and at least one first recess extending outwardly of the frame from the second inner surface. Each of the first and second inner surfaces has at least one second recess positionally corresponding to the second surface of the light guide plate. Further, the light guide plate has first and second projections extending from the first and second side edge surfaces to engage in the first and second recesses, respectively.

Specifically, two first recesses may be provided on each of the first and second inner surfaces. One second recess may be provided at an intermediate position between the two first recesses on the first inner surface, and another second recess may be provided at an intermediate position between the two first recesses on the second inner surface.

A prism sheet may be provided between the shielding-reflecting sheet and the second liquid crystal panel at a position corresponding to the opening of the shielding-reflecting sheet to increase the brightness of the second liquid crystal panel. Specifically, the prism sheet may be fixed to the peripheral edge of the opening.

In addition, the present invention provides a backlight unit that is provided between a first liquid crystal panel and a second liquid crystal panel, which are disposed parallel to each other, to illuminate both the first and second liquid crystal panels. The backlight unit includes a light source and a light guide plate installed parallel to the first and second liquid crystal panels to receive light emitted from the light source and to emit light for illuminating the two liquid crystal panels. An annular frame is installed so as to surround the peripheral edge of the light guide plate. The frame has a first end surface on a side thereof closer to the first liquid crystal panel and a second end surface on a side thereof closer to the second liquid crystal panel. A shielding-reflecting sheet is disposed between the second liquid crystal panel and the light guide plate to shield and reflect light emitted from the light guide plate. The shielding-reflecting sheet is fixed to the second end surface of the frame to form, in cooperation with the frame, a casing that houses the light source and the light guide plate. The shielding-reflecting sheet has an opening through which light emitted from the light guide plate passes toward the second liquid crystal panel. A prism sheet is provided between the shielding-reflecting sheet and the second liquid crystal panel at a position corresponding to the opening of the shielding-reflecting sheet. The prism sheet is stretched across the opening. Respective surfaces of the shielding-reflecting sheet and the second liquid crystal panel that face the light guide plate have respective reflectances that are set so that light emitted from the light guide plate toward the second liquid crystal panel is reflected back to the light guide plate uniformly across the light guide plate by the surfaces of the shielding-reflecting sheet and the second liquid crystal panel.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1A is a sectional view of a backlight unit according to an embodiment of the present invention.

FIG. 1B is a fragmentary enlarged sectional view of part 1B in FIG. 1A.

FIG. 1C is a fragmentary enlarged sectional view similar to FIG. 1B, which shows another way in which a semitransmitting-reflecting sheet and a shielding-reflecting sheet are installed.

FIG. 2A is a plan view of a shielding-reflecting sheet used in the embodiment of the present invention.

FIG. 2B is a sectional view taken along the line 2B-2B in FIG. 2A.

FIG. 3A is a sectional view of a backlight unit according to another embodiment of the present invention.

FIG. 3B is a fragmentary enlarged sectional view of part B in FIG. 3A.

FIG. 4 is a sectional view of a backlight unit according to the conventional art.

FIG. 5 is a sectional view of another backlight unit according to the conventional art.

FIG. 6 is a view as seen in the direction of the arrow VI-VI in FIG. 1A.

FIG. 7 is a view as seen in the direction of the arrow VII-VII in FIG. 1A.

FIG. 8 is a view as seen in the direction of the arrow VIII-VIII in FIG. 6.

FIG. 9 is an enlarged view of part IX in FIG. 8.

FIG. 10 is an enlarged view of part X in FIG. 8.

### DESCRIPTION OF THE PREFERRED EMBODIMENTS

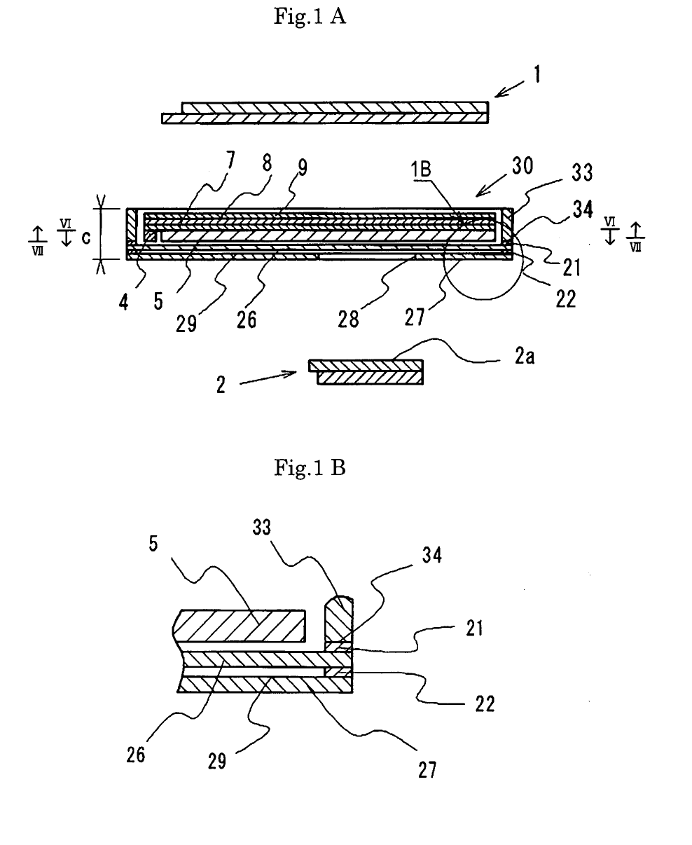

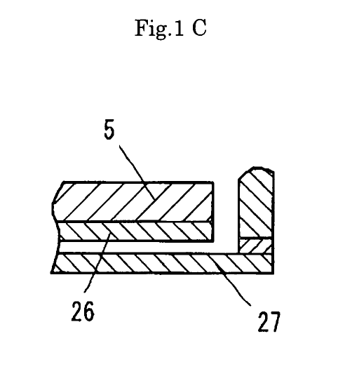

Embodiments of the backlight unit according to the present invention will be described below in detail with reference to FIGS. 1A to 3B and 6 to 10.

As shown in FIGS. 1A and 1B, a backlight unit 30 according to an embodiment of the present invention has an LED light source 4 and a rectangular light guide plate 5. A rectangular diffusing sheet 7 and rectangular prism sheets 8 and 9 are successively stacked on the upper surface of the light guide plate 5. A rectangular frame 33 surrounds the LED light source 4 and other constituent elements 5, 7, 8 and 9. A rectangular semitransmitting-reflecting sheet 26 is fixed to a lower end surface 34 of the frame 33 with a double-coated adhesive sheet 21. A rectangular shielding-reflecting sheet 27 is stacked over the semitransmitting-reflecting sheet 26 and fixed thereto with a double-coated adhesive sheet 22. A first liquid crystal panel 1 with a large screen size is placed above the backlight unit 30. A second liquid crystal panel 2 with a small screen size is placed below the backlight unit 30. The shielding-reflecting sheet 27 is provided with an opening 28 at a position facing the second liquid crystal panel 2. As shown in FIG. 1C, the arrangement may be such that the semitransmitting-reflecting sheet 26 is disposed on the lower surface of the light guide plate 5, and the shielding-reflecting sheet 27 is bonded directly to the lower end surface 34 of the frame 33.

The frame 33 may be formed of a synthetic resin material. The LED light source 4 is positioned adjacent to an end edge surface of the light guide plate 5. The light guide plate 5 receives light emitted from the LED light source 4 through the end edge surface thereof and emits light in both upward and downward directions. The diffusing sheet 7 uniformly diffuses light emitted from the light guide plate 5. The prism sheets 8 and 9 adjust the angle of incidence of light on the first liquid crystal panel 1 so that light diffused by the diffusing sheet 7 impinges on the first liquid crystal panel 1 as perpendicularly thereto as possible. The diffusing sheet 7 and the prism sheets 8 and 9 are general-purpose ones. Therefore, a detailed description thereof is omitted herein.

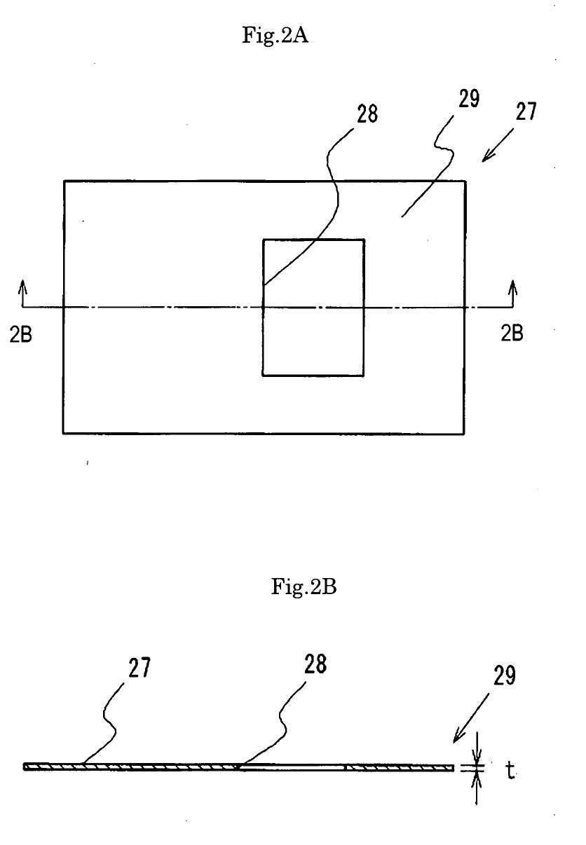

As shown in FIG. 2B, the shielding-reflecting sheet 27 is preferably made of a synthetic resin material having a thickness t of about 0.04 mm to 0.25 mm. The light reflectance of a surface 29 of the shielding-reflecting sheet 27 that faces the semitransmitting-reflecting sheet 26 is preferably substantially equal to the light reflectance of a surface 2a of the second liquid crystal panel 2 that faces the semitransmitting-reflecting sheet 26. The reflectance of the surface 29 can be adjusted by coloring. As a method of coloring the surface 29, a sheet material made of a colored synthetic resin material may be used. It is, however, preferable to coat a sheet material with a coloring coating material by printing using ink, for example.

In the backlight unit 30, light emitted from the upper surface of the light guide plate 5 is applied to the first liquid crystal panel 1 through the diffusing sheet 7 and the prism sheets 8 and 9. Light emitted from the lower surface of the light guide plate 5 is applied to the second liquid crystal panel 2 through the semitransmitting-reflecting sheet 26 and the opening 28 in the shielding-reflecting sheet 27.

Because the light reflectance of the surface 29 of the shielding-reflecting sheet 27 is set substantially equal to the light reflectance of the surface 2a of the second liquid crystal panel 2 that faces the semitransmitting-reflecting sheet 26, as stated above, light directed toward the second liquid crystal panel 2 from the light guide plate 5 is incident on both the surface 29 of the shielding-reflecting sheet 27 and the surface 2a of the second liquid crystal panel 2 and reflected therefrom with reflectances substantially equal to each other. Accordingly, the brightness unevenness seen when the display screen of the first liquid crystal panel 1 is viewed is reduced to a considerable extent in comparison to the use of the above-described conventional backlight unit.

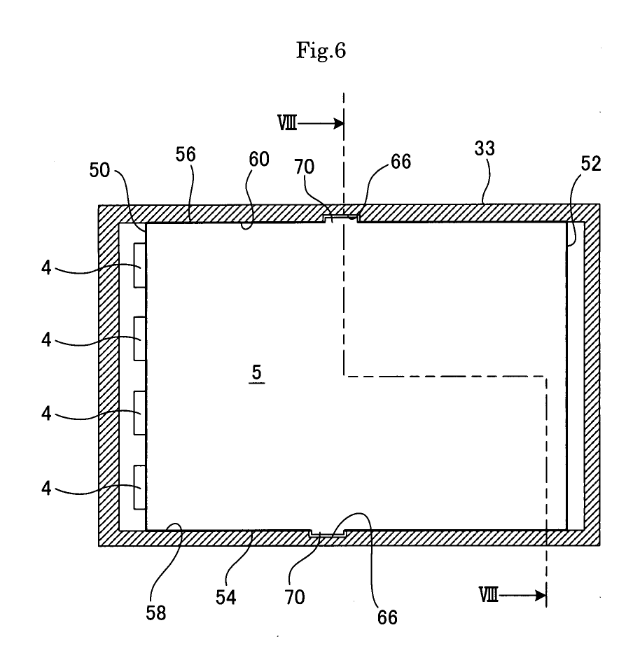

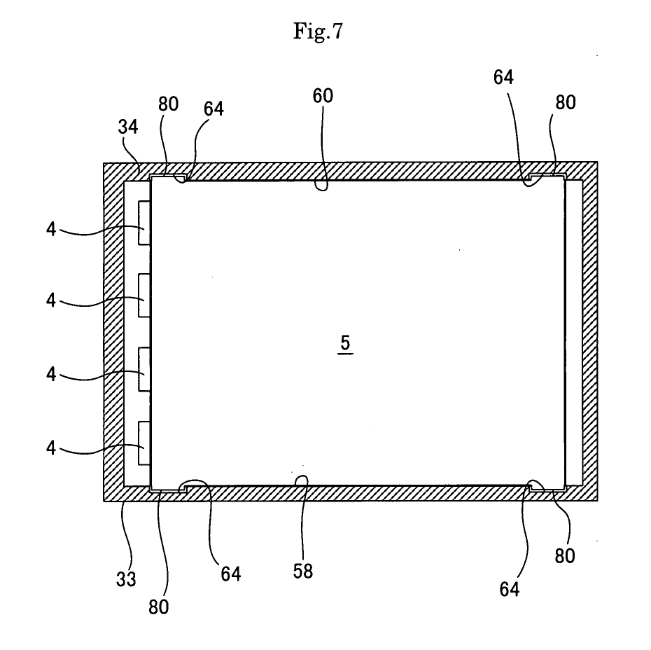

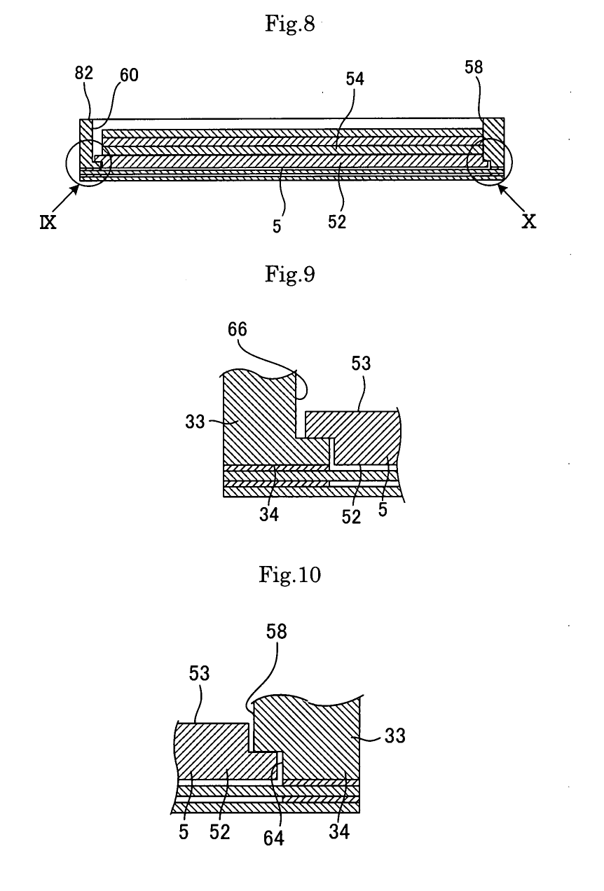

FIGS. 6 and 7 are views as seen in the directions of the arrows VI-VI and VII-VII, respectively, in FIG. 1A. FIG. 8 is a view as seen in the direction of the arrow VIII-VIII in FIG. 6. FIGS. 9 and 10 are enlarged views of parts IX and X, respectively, in FIG. 8.

As illustrated in the figures, the light guide plate 5 has a first end edge surface 50 adjacent to the LED light source 4 and a second end edge surface 51 opposite to the first end edge surface 50. The light guide plate 5 further has first and second side edge surfaces 54 and 56, a lower surface 52, and an upper surface 53. The lower surface 52 is flush with the lower end surface 34 of the frame 33.

The frame 33 has first and second inner surfaces 58 and 60 disposed adjacent to the first and second side edge surfaces 54 and 56, respectively, of the light guide plate 5 to support them fixedly. Specifically, the lower end surface 34 of the frame 33 is configured to have at least one first recesses 64 extending outwardly of the frame 33 from the first inner surface 58 and at least one first recesses 64 extending outwardly of the frame 33 from the second inner surface 60. Further, each of the first and second inner surfaces 58, 60 has at least one second recess 66 positionally corresponding to the upper surface 53 of the light guide plate. In the illustrated example, two spaced first recesses 64 are provided on each of the first and second inner surfaces 58 and 60. One second recess 66 is provided at an intermediate position between the two first recesses 64 on the first inner surface 58. Similarly, one second recess 66 is provided at an intermediate position between the two first recesses 64 on the second inner surface 60. Further, in the illustrated example, the second recess 66 extend from the upper end surface 82 of the frame 33 to near the lower end surface 34 thereof. The light guide plate 5 has the first and second projections 70 and 80 engaged in the first and second recesses 64 and 66, thereby being prevented from moving vertically and horizontally.

As has been stated above, the backlight unit 30 according to the foregoing embodiment uses the frame 33 instead of the casing 3 having a bottom wall as in the conventional backlight unit. The frame 33 has the semitransmitting-reflecting sheet 26 and the shielding-reflecting sheet 27 stretched over the bottom thereof to form a casing-like configuration. The LED light source, the light guide plate and so forth, which are housed in the casing-like configuration, are secured to the frame 33. Accordingly, the backlight unit 30 according to the foregoing embodiment can be reduced in thickness as compared with the conventional backlight unit. Because the thickness t of shielding-reflecting sheet 27 can be properly changed, it is possible to adjust the thickness c of the backlight unit 30 to the space in a portable device such as a cellular phone in which the backlight unit 30 is to be installed. In addition, the casing (i.e. the frame 33) becomes simple in configuration, which allows a cost reduction of the backlight unit 30.

In addition, the shielding-reflecting sheet 27 can be subjected to fine color adjustment easily by ink printing or the like. Therefore, the adjustment of the reflectance of the shielding-reflecting sheet 27 is facilitated. Consequently, it becomes possible to reduce brightness unevenness occurring on a first liquid crystal panel having a larger screen size when two (first and second) liquid crystal display panels are illuminated with light from a common backlight unit.

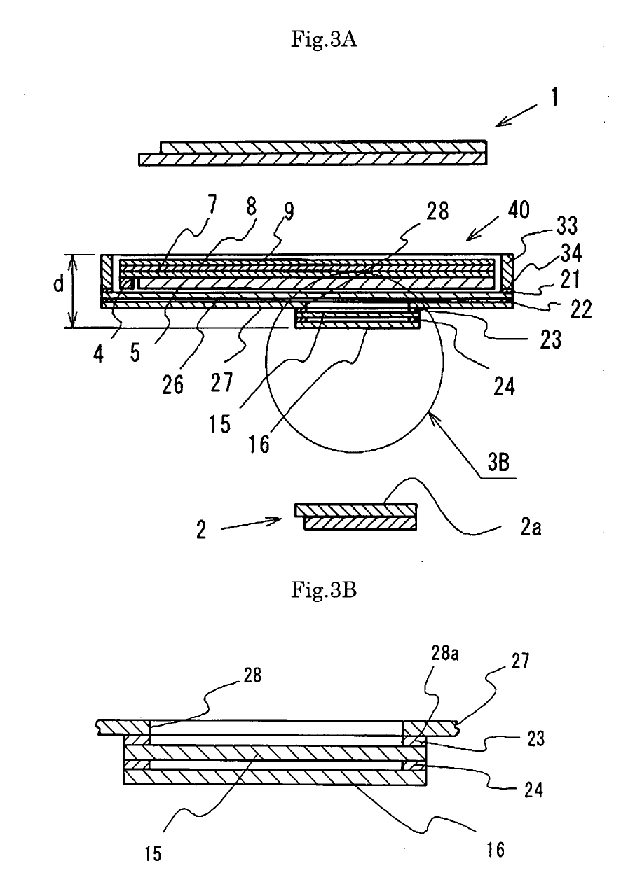

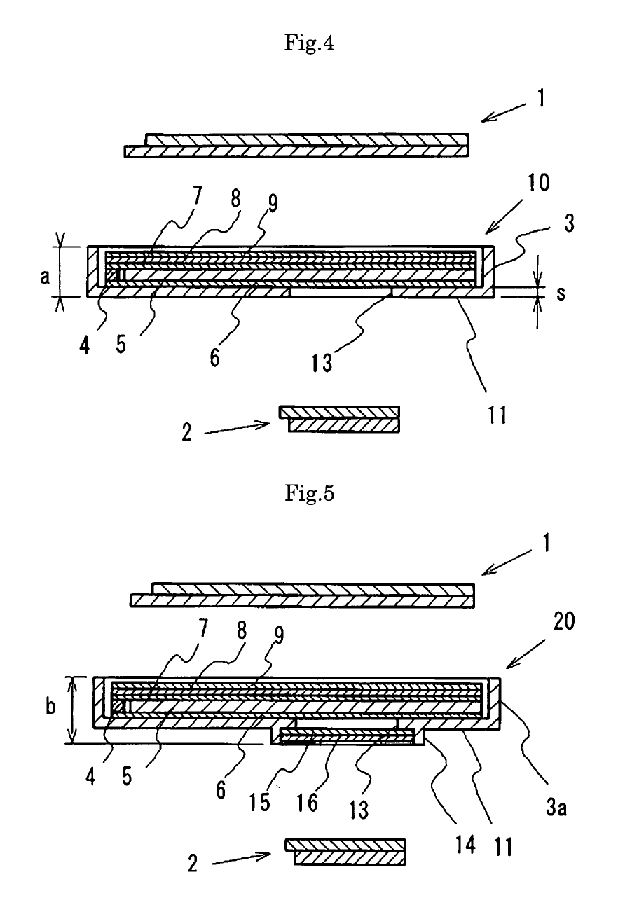

It should be noted that FIGS. 3A and 3B show a backlight unit 40 according to another embodiment of the present invention, which is applied when the second liquid crystal panel 2 requires a particularly high brightness. The backlight unit 40 has two superimposed prism sheets 15 and 16 stretched over the opening 28 of the shielding-reflecting sheet 27 in the foregoing backlight unit 30. The prism sheet 15 is adhesively secured to a peripheral edge portion 28a of the opening 28 with a double-coated adhesive sheet 23. An outer peripheral edge portion of the prism sheet 16 is adhesively secured to the prism sheet 15 with a double-coated adhesive sheet 24. The rest of the backlight unit 40 is the same as that of the foregoing backlight unit 30, which is shown in FIG. 1A. Therefore, a description thereof is omitted herein. According to this embodiment, the same advantageous effects as with the foregoing backlight unit 30 can be obtained. In addition, it is possible to obtain a backlight unit 40 having a high-brightness second liquid crystal panel 2.

It should be noted that the present invention is not necessarily limited to the foregoing embodiments but can be modified in a variety of ways without departing from the gist of the present invention.

What is claimed is:

1. A backlight unit that is disposed between a first liquid crystal panel and a second liquid crystal panel, which are arranged parallel to each other, to illuminate both the first and second liquid crystal panels, said backlight unit comprising:
a light source;
a light guide plate disposed parallel to the first and second liquid crystal panels and adapted to receive light emitted from said light source and emit the light for illuminating said first and second liquid crystal panels; and
a shielding-reflecting sheet disposed between said second liquid crystal panel and said light guide plate in parallel to them to shield and reflect light emitted from said light guide plate;
said shielding-reflecting sheet having an opening through which light emitted from said light guide plate passes toward said second liquid crystal panel;
wherein respective surfaces of said shielding-reflecting sheet and said second liquid crystal panel that face said light guide plate have respective reflectances that are set so that light emitted from said light guide plate toward said second liquid crystal panel is reflected back to said light guide plate uniformly across said light guide plate by said respective surfaces of said shielding-reflecting sheet and said second liquid crystal panel.

2. A backlight unit according to claim 1, wherein the reflectance of the surface of said shielding-reflecting sheet that faces said light guide plate and the reflectance of the surface of said second liquid crystal panel that faces said light guide plate are equal to each other.

3. A backlight unit according to claim 2, wherein the surface of said shielding-reflecting sheet that faces said light guide plate has been colored to adjust said reflectance.

4. A backlight unit according to claim 1, further comprising:
a frame surrounding a peripheral edge of said light guide plate and having a first end surface on a side thereof closer to said first liquid crystal panel and a second end surface on a side thereof closer to said second liquid crystal panel;
wherein said shielding-reflecting sheet is fixed to the second end surface of said frame to form, in cooperation with said frame, a casing-like configuration that houses said light source and said light guide plate.

5. A backlight unit according to claim 4, further comprising:
a semitransmitting-reflecting sheet disposed between said shielding-reflecting sheet and said light guide plate.

6. A backlight unit according to claim 5, wherein said semitransmitting-reflecting sheet is fixed to the second end surface of said frame, and a peripheral edge portion of said shielding-reflecting sheet is fixed to the second end surface of said frame through said semitransmitting-reflecting sheet.

7. A backlight unit according to claim 4, wherein said light guide plate is secured to an inner peripheral surface of said frame.

8. A backlight unit according to claim 7, wherein said light guide plate is rectangular and has:
a rectilinear end edge surface for receiving light from said light source;
an end edge surface opposite to said rectilinear end edge surface; and
first and second side edge surfaces extending between said rectilinear end edge surface and said end edge surface;
wherein said frame has first and second inner surfaces positioned to face said first and second side edge surfaces, respectively, to fixedly support said first and second side edge surfaces.

9. A backlight unit according to claim 8,
wherein said first and second inner surfaces of said frame are positioned adjacent to the first and second side edge surfaces of said light guide plate, respectively;
wherein said light guide plate has:
a first surface flush with the second end surface of said frame, and
a second surface located closer to the first end surface of said frame than said first surface;
wherein said second end surface of said frame is configured to have at least one first recesses extending outwardly of said frame from said first inner surface and at least one first recesses extending outwardly of said frame from said second inner surface;
wherein each of said first and second inner surfaces has at least one second recess positionally corresponding to said second surface of said light guide plate; and,
wherein said light guide plate has first and second projections extending from said first and second side edge surfaces to engage in said first and second recesses, respectively.

10. A backlight unit according to claim 9,
wherein said at least one first recess comprises two first recesses spaced apart from each other and said at least one second recess comprises one second recess positioned between said respective two first recesses.

11. A backlight unit according to claim 2, further comprising:
a prism sheet disposed between said shielding-reflecting sheet and said second liquid crystal panel at a position corresponding to the opening of said shielding-reflecting sheet.

12. A backlight unit according to claim 11, wherein said prism sheet is fixed to a peripheral edge of said opening.

13. A backlight unit disposed between a first liquid crystal panel and a second liquid crystal panel, which are arranged parallel to each other, to illuminate both the first and second liquid crystal panels, said backlight unit comprising:
a light source;
a light guide plate disposed parallel to the first and second liquid crystal panels to receive light emitted from said light source and emit light for illuminating said first and second liquid crystal panels;
an annular frame surrounding a peripheral edge of said light guide plate, said frame having a first end surface on a side thereof closer to said first liquid crystal panel and a second end surface on a side thereof closer to said second liquid crystal panel;
a shielding-reflecting sheet disposed between said second liquid crystal panel and said light guide plate to shield and reflect light emitted from said light guide plate, said shielding-reflecting sheet being fixed to the second end surface of said frame to form, in cooperation with said frame, a casing that houses said light source and said light guide plate, and said shielding-reflecting sheet having an opening through which light emitted from said light guide plate passes toward said second liquid crystal panel; and
a prism sheet disposed between said shielding-reflecting sheet and said second liquid crystal panel at a position corresponding to the opening of said shielding-reflecting sheet, said prism sheet being stretched across said opening;
wherein respective surfaces of said shielding-reflecting sheet and said second liquid crystal panel that face said light guide plate have respective reflectances that are set so that light emitted from said light guide plate toward said second liquid crystal panel is reflected back to said light guide plate uniformly across said light guide plate by said surfaces of said shielding-reflecting sheet and said second liquid crystal panel.

14. A backlight unit according to claim 13, wherein the surface of said shielding-reflecting sheet that faces said light guide plate has been colored to adjust said reflectance.
